(19) United States
(12) Patent Application Publication
(10) Pub. No.: US 2014/0207508 A1
(43) Pub. Date: Jul. 24, 2014

(54) SYSTEM AND METHODS FOR WORKFORCE EXCHANGE

(71) Applicant: Richard Faulkner, Suffolk, VA (US)

(72) Inventor: Richard Faulkner, Suffolk, VA (US)

(73) Assignee: IQ Exchange, LLC, Suffolk, VA (US)

(21) Appl. No.: 13/748,389

(22) Filed: Jan. 23, 2013

(51) Int. Cl. G06Q 10/06

(52) U.S. Cl. CPC G06Q 10/063116
USPC 705/7.16

(57) ABSTRACT

A method for exchanging one or more employees includes providing access to a resource system to at least one offerer and at least one requester, the access being provided over an electronic network, allowing the offerer to post within the resource system data associated with one or more employees currently under the employ of the offerer, and allowing the requester to view, in response to a search within the resource system, a data record associated with the posted one or more employees of the offerer. The method further includes facilitating, within the resource system, an agreement process between the offerer and the requester to exchange the employee from the offerer to the requester for a limited time, the resource system being owned by a resource service entity that is separate from the offerer and the requester.

### TECHNICAL FIELD

The present disclosure relates generally to a system and method for workforce exchange.

### BACKGROUND

Variations in demand for goods or services can result in significant workforce turbulence for an entity supplying such goods or services. For example, when demand for goods or services is low, an entity may have more employees than is necessary to meet demand. This employee surplus may significantly affect the revenue of the entity, and eventually force the entity to dismiss employees. Depending on the extent of the variations in demand, the entity may have to dismiss very talented and experienced employees.

When the demand for the goods or services increases, the entity may struggle because it now lacks enough employees to meet the rise in demand. The dismissed employees may no longer be available for rehiring by the entity. In addition, the cost to the entity in hiring and training employees to meet the new demand can be significant. To further compound these difficulties for the entity, employees of entities that are subject to these variations in demand may preemptively seek opportunities with other entities that are less susceptible to the variations in demand.

The present disclosure is directed to overcoming one or more of the issues discussed above, and/or overcoming other issues in the art.

### SUMMARY

In one aspect, the present disclosure is directed to a method for exchanging one or more employees. The method includes providing access to a resource system to at least one offerer and at least one requester, the access being provided over an electronic network, allowing the offerer to post within the resource system data associated with one or more employees currently under the employ of the offerer, and allowing the requester to view, in response to a search within the resource system, a data record associated with the posted one or more employees of the offerer. The method further includes facilitating, within the resource system, an agreement process between the offerer and the requester to exchange the employee from the offerer to the requester for a limited time, the resource system being owned by a resource service entity that is separate from the offerer and the requester.

In another aspect, the present disclosure is directed to a system for exchanging one or more employees. The system includes an electronic storage device storing instructions for administering a resource management system, and a processor configured to execute instructions to perform a method. The method includes providing access to a resource system to at least one offerer and at least one requester, the access being provided over an electronic network, allowing the offerer to post within the resource system data associated with one or more employees currently under the employ of the offerer, and allowing the requester to view, in response to a search within the resource system, a data record associated with the posted one or more employees of the offerer. The method further includes facilitating, within the resource system, an agreement process between the offerer and the requester to exchange the employee from the offerer to the requester for a limited time, the resource system being owned by a resource service entity that is separate from the offerer and the requester.

### BRIEF DESCRIPTION OF THE DRAWINGS

FIG. 1 is a block diagram of an exemplary system architecture, consistent with certain disclosed embodiments;

FIG. 2 is a flow chart illustrating an exemplary employee exchange process, consistent with certain disclosed embodiments;

FIG. 3 is a flow chart illustrating an exemplary process within the employee exchange process, consistent with certain disclosed embodiments;

FIG. 4 is a flow chart illustrating an exemplary process within the employee exchange process, consistent with certain disclosed embodiments;

FIG. 5 is a flow chart illustrating an exemplary process within the employee exchange process, consistent with certain disclosed embodiments; and

FIG. 6 is a flow chart illustrating an exemplary process within the employee exchange process, consistent with certain disclosed embodiments.

### DETAILED DESCRIPTION

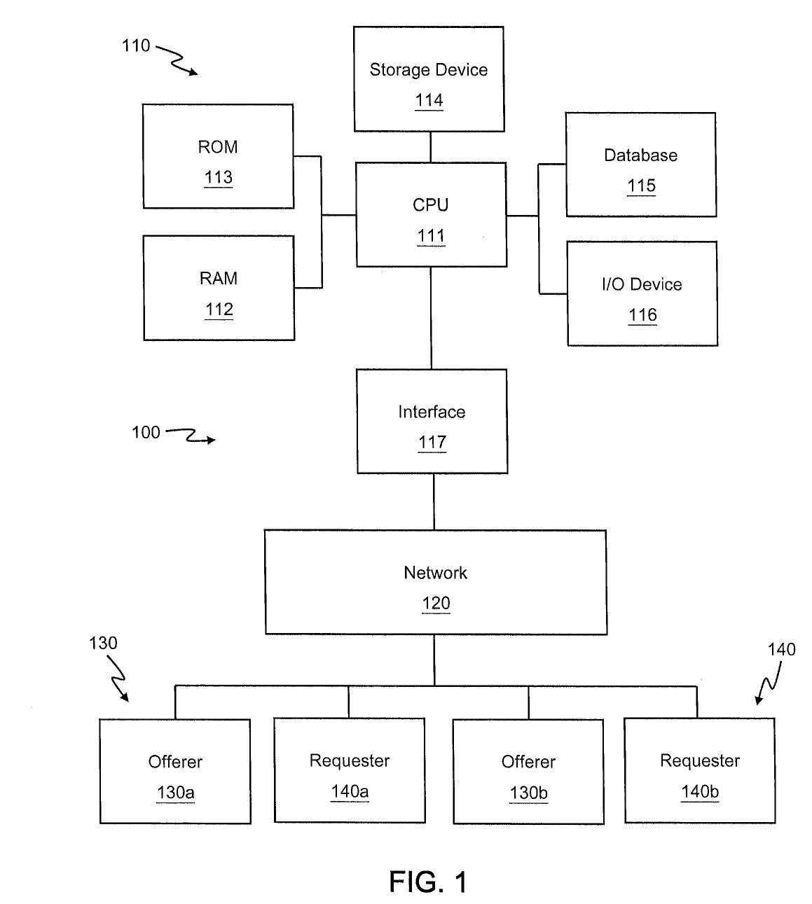

FIG, 1 illustrates an exemplary system architecture 100 in which principles and methods consistent with the disclosed embodiments may be implemented. As shown in FIG. 1, system architecture 100 may include one or more hardware and/or software components configured to collect, monitor, store, analyze, evaluate, distribute, report, process, record, and/or sort information associated with a resource management system for exchanging employees of one entity with another entity. As used herein, the “exchange” of an employee includes exchanging an employee from one entity for a fee or for one or more employees of the other entity, or for any other type of compensation or value to the employee's entity, including merely for the knowledge and/or experience gained by the employee as part of the exchange. In addition, the term “exchange” does require a particular duration, but can be for a fixed duration or for an open-ended duration.

As shown in FIG. 1, system architecture 100 may include resource management computing system 110, network 120, offerers 130, and requesters 140. Resource management computing system 110 may include one or more hardware and/or software components such as, for example, a central processing unit (CPU) 111, a random access memory (RAM) module 112, a read-only memory (ROM) module 113, storage device 114, a database 115, one or more input/output (I/O) devices 116, and an interface 117. Resource management computing system 110 may be configured to receive, collect, analyze, evaluate, report, display, and distribute data related to an employee exchange process, and may use one or more software components or applications. For example, resource management computing system 110 may be configured to initiate, manage, facilitate, and track employee exchanges between entities, and perform automated processing based on the exchanges. Resource management computing system 110 may include, for example, a mainframe, a server, a system of servers, a desktop, a laptop, or any combination thereof.

CPU 111 may include one or more processors, each configured to execute instructions and process data to perform functions associated with resource management computing system 110. As illustrated in FIG. 1, CPU 111 may be connected to RAM 112, ROM 113, storage 114, database 115, I/O devices 116, and interface 117. CPU 111 may be configured to execute computer program instructions to perform various processes and methods consistent with certain disclosed embodiments. The computer program instructions may be loaded into RAM 112 for execution by CPU 111.

RAM 112 and ROM 113 may each include one or more devices for storing information associated with an operation of resource management computing system 110 and/or CPU 111. For example, ROM 113 may include a memory device configured to access and store information associated with resource management computing system 110, including information for identifying, initializing, and monitoring the operation of one or more components and subsystems of resource management computing system 110. RAM 112 may include a memory device for storing data associated with one or more operations performed by CPU 111. For example, instructions from ROM 113 may be loaded into RAM 112 for execution by CPU 111.

Storage device 114 may include any type of electronic storage device configured to store any type of information used by CPU 111 to perform one or more processes consistent with the disclosed embodiments. For example, storage 114 may include one or more magnetic and/or optical disk devices, such as hard drives, CD-ROMs, DVD-ROMs, or any other type of media storage device.

Database 115 may include one or more software and/or hardware components that store, organize, sort, filter, and/or arrange data used by resource management computing system 110 and/or CPU 111. Database 115 may include a relational, distributed, or any other suitable database format. A relational database may be in tabular form where data may be organized and accessed in various ways. A distributed database may be dispersed or replicated among different locations within a network. For example, database 115 may store information such as a list of employees that may be available for exchange, employee attributes, or any other information that may be used by CPU 111 to perform features of the employee exchange. Database 115 may also include one or more analysis tools for analyzing information within the database. Database 115 may store additional and/or different information than that listed above.

I/O devices 116 may include one or more components configured to communicate information with a user (offerer, requester, and/or resource management service entity) associated with resource management computing system 110. For example, I/O devices 116 may include a console with an integrated keyboard and mouse to allow a user to input parameters for use in resource management computing system 110. I/O devices 116 may also include a user-accessible disk drive (e.g., a USB port, a floppy, CD-ROM, or DVD-ROM drive, etc.) to allow a user to input data stored on a portable media device. Additionally, I/O devices 116 may include one or more displays or other peripheral devices, such as, for example, a printer, a camera, a microphone, a speaker system, an electronic tablet, any mobile media device, and/or any other suitable type of input/output device.

Interface 117 may include one or more components configured to transmit and/or receive data via network 120. For example, interface 117 may include one or more modulators, demodulators, multiplexers, de-multiplexers, network communication devices, wireless devices, antennas, modems, and any other type of device configured to enable data communication via any suitable communication network. It is further anticipated that interface 117 may be configured to allow CPU 111, RAM 112, ROM 113, storage 114, database 115, and one or more input/output (I/O) devices 116 to be located remotely from one another and perform the collection, analysis, and distribution of data or other information.

Resource management computing system 110 may include additional, fewer, and/or different components than those listed above and it is understood that the listed components are exemplary only and not intended to be limiting. For example, one or more of the hardware components listed above may be implemented using software. For example, storage device 114 may include a software partition associated with one or more other hardware components of resource management computing system 110. Additional hardware or software may also be required to operate resource management computing system 110, such as, for example, security applications, authentication systems, dedicated communication system, etc. In addition, resource management computing system 110 may be updated with new hardware and/or software as these technologies develop. As will be explained in more detail below, the hardware and/or software may be interconnected and accessed as required by authorized users. In addition, a portion, or all of, resource management computing system 110 may be hosted and/or operated by a third party such as a resource management service entity. In addition, any or all of 110 may be implemented in a web server system, cloud environment, or any other remote computing systems.

As discussed above, computer system may be in communication with network 120 by means of interface 117. Network 120 may be any appropriate communication network allowing communication between or among one or more entities. Network 120 may include, for example, the Internet, a local area network, a workstation peer-to-peer network, a direct link network, a wireless network, or any other suitable communication platform. Connection with network 120 may be wired, wireless, or any combination thereof.

Offerer 130 corresponds to an entity that is interested in exchanging one or more of its employees within the resource management computing system 110. The term “entity” as used herein means any type of entity that has one or more employees, such as an entity, corporation, subsidiary, partnership, government entity, etc. In addition, the resource management computing system 110 may be used by any number of different offerers 130a, 130b. It is understood that the offerer 130 includes users of the resource management computing system 110 that are authorized to act on behalf of the offerer 130. Offerer 130 may connect to network 120 using any suitable computing device, such as, for example a desktop computer, a laptop computer, a mainframe computer, a client device, a handheld computing device, a telephone, etc. The connection between the offerer 130 and network 120 may be through any wired or wireless means.

Requester 140 corresponds to an entity that is interested in receiving one or more employees through the resource management computing system 110. For example, the entity may be a company that requires a position to be filled only temporarily (e.g., less than a year), and wants to avoid the expense and commitments associated with a hiring and maintaining a full time employee. The resource management computing system 110 may be used by any number of different requesters 140a, 140b. Similar to the offerer 130 discussed above, the requester 140 includes users of the resource management computing system 110 that are authorized to act on behalf of the requester 140. In some instances, the requester 140 may also use the resource management computing system 110 as an offerer 130, and visa versa. Requester 140 may connect to network 120 using any suitable computing device, such as, for example a desktop computer, a laptop computer, a mainframe computer, a client device, a handheld computing device, a telephone, etc. The connection between the requester 140 and network 120 may be through any wired or wireless means.

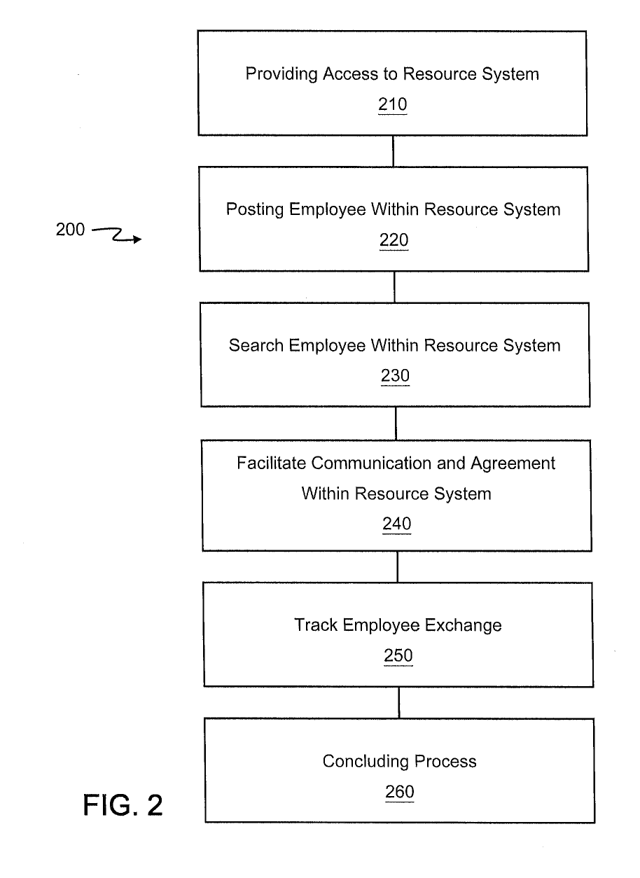

FIG. 2 illustrates a flowchart 200 of an exemplary employee exchange process, consistent with certain disclosed embodiments. In one embodiment, the process of FIG. 2 may be performed by resource management computing system 110. For example, resource management computing system 110 may execute one or more software programs that perform one or more of the process steps shown in FIG. 2.

As noted above, in one exemplary embodiment, resource management computing system 110 may be owned, operated, and/or supported, either in whole or in part, by a resource management service entity, that is separate from the offerer 130 and requester 140. The resource management service entity may be, for example, an individual, business, or other organization that facilitates the exchange of employees from offerers 130a, 130b, and requesters 140a, 140b. Alternatively and/or additionally, resource management computing system 110 may be owned, operated, and/or supported, either in whole or in part, by one or more of an offerer 130, or requester 140.

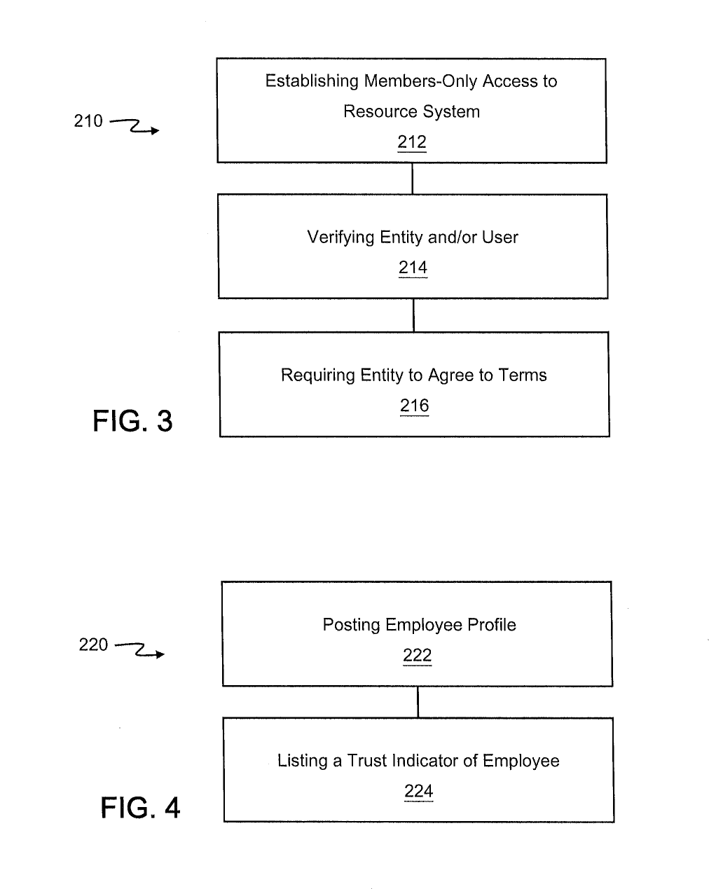

Employee exchange process 200 includes providing access into the resource management computing system 110 to offerers 130 and requesters 140 (step 200). Referring to FIG. 3, the access may include a fee driven membership-only type access into the resource management computing system 110 (step 212). For example, offerer 130 and requester 140 may be required to enroll in the employee exchange process 200, with membership being contingent upon certain conditions being met. These conditions may include, for example, one or more of a verification process to ensure that offerer 130 and/or requester 140 is a reputable entity, and/or that the user requesting membership on behalf of the offerer 130 or requester 140 has authority to bind the offerer 130 or requester 140 (step 214). Alternatively or additionally, employee exchange process 200 may include one or more free services having open-type access. The enrollment process may also include the offerer 130 or requester 140 selecting a membership type, billing options, notification preferences, and authorized users on behalf of the entity. In addition, access to the resource management computing system 110 may be contingent upon the offerer 130 and/or requester 140 agreeing to a certain terms and/or conditions associated with the use of the system (step 216). Data received during process 210 and/or associated with one or more offerers 130 and requesters 140 may be stored in database 115. For example, database 115 may store membership type, billing options, preferences, etc. for each offerer 130 and requester 140.

Referring back to FIG. 2, employee exchange process 200 includes transmitting or “posting” within the resource management computing system 110 one or more employees that are available for exchange by the offerer 130 (step 220). The posting of employees may include the offerer 130 creating a data profile of the employee to be posted (FIG. 3, step 222). The employee data profile may include traits and/or attributes of the employee, such as, for example, the employee's educational background, work experience, awards, and/or any other information that may be relevant to a potential requester 140. The information may be entered into the resource management computing system 110 by way of I/O device 116 (FIG. 1) in a free-form fashion, or through a traits/attributes menu provided by the resource management computing system 110. The posting of the employee can be done in such a manner as to keep the identity of the employee and the offerer 130 unavailable to the requester 140 until such time as the offerer 130 desires.

The posting of an employee within the resource management computing system 110 may include providing an employee trust indicator (FIG. 4, step 224). The trust indicator may be a numerical value or other indicator, separate from the identified traits or attributes of the employee, that attempts to quantify the overall trustworthiness of the posted employee. For example, the trust indicator may be similar to credit scores for individuals, but attempts to approximate the honesty, reliability, and/or responsibility of the individual, rather than merely the financial reliability of individual.

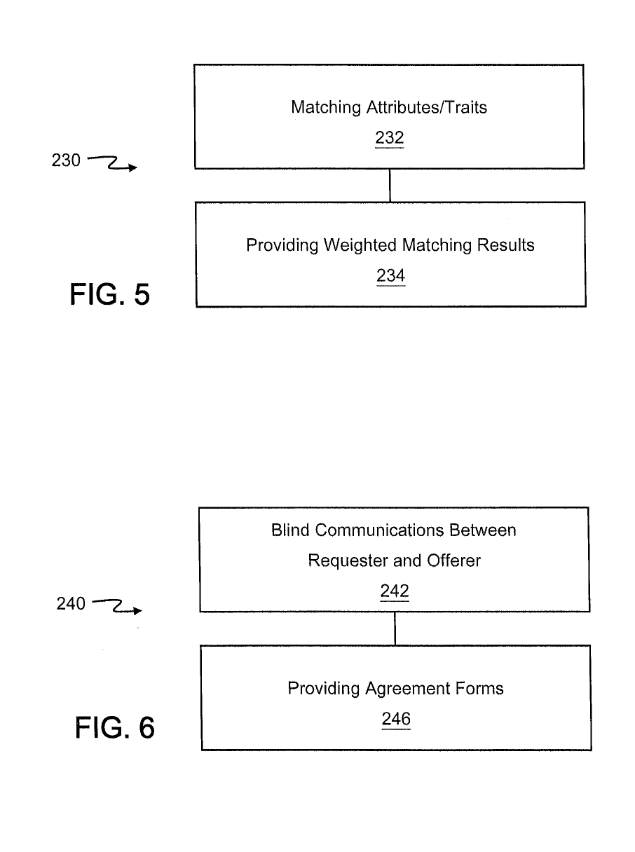

Employee exchange process 200 also includes searching within the resource management computing system 110 by the requester 140 for one or more employees that have been posted for exchange by an offerer 130 (step 230). The searching may include the requester 140 submitting search queries through the I/O device 116 (FIG. 1) with requester-desired traits/attributes. The search queries may be submitted in any appropriate form, such as free-form search queries and/or menu driven queries prompted within the resource management computing system 110. The data record results of the search can be provided, for example, through I/O device 116 to the requester 140, such as being viewable on a display on an I/O device 116. The results provided can be narrowed, expanded, saved, or discarded, as desired. In one embodiment, the search results can be provided in a weighted fashion based on specific predetermined or supplied traits/attributes (FIG. 5, step 234).

Once the requester 140 has identified one or more offerer employees that the requester 140 potentially desires, the employee exchange process 200 provides a method for the requester 140 to contact the offerer 130 and initiate an agreement between the requester 140 and offerer 130 (step 240). The initial contact from the requester 140 to the offerer 130 may be within the resource management computing system 110. For example, the resource management computing system 110 may include a messaging system that allows the requester 140 to send messages to an offerer 130. In one embodiment, these messages can be retrieved by the offerer 130 within the resource management computing system 110 when the offerer 130 is logged into the system. This messaging system may be configured to keep the identity of the offerer 130 and/or requester 140 hidden, and thus allow for initial blind communications between the requester 140 and offerer 130 (FIG. 6, step 242). Thereafter, the offerer 130 and requester 140 can decide to identify themselves. The messages, and any other notifications provided as part of the employee exchange process 200, may be sent and received via e-mail, text message, instant messaging, and/or any other conventional message sending platform. The message sending platform may be selected by the entity within the employee exchange process 200, for example, via customized menus available during enrollment in the employee exchange process 200.

Employee exchange process 200 may then facilitate the formation of an agreement between the requester 140, and the offerer 130 for the exchange of the employee from the offerer 130 to the requester 140 (step 240). The exchange may take many different forms, including different compensation arrangements, durations, and/or contingencies. For example, one exchange agreement may include the offerer 130 exchanging the employee as a loan to the requester 140 for a limited time and for an hourly fee. In another agreement arrangement, the exchange may be a permanent move of the employee to the requester 140 for an agreed upon fixed fee. The resource management computing system 110 may facilitate the agreement process by providing electronic forms or other data platforms within the system that can be completed by the offerer 130 and/or requester 140 to negotiate the terms of the employee exchange from the offerer 130 to the requester 140. As noted above, such terms can include, for example, standard employment provisions including the duration of the exchange, fees to be paid, and other expectations of the parties. The electronic forms used within the resource management system may include a term sheet, non-disclosure agreement, employment agreement, and/or any other forms that could be relevant to the exchange of an employee from the offerer 130 to the requester 140.

The agreement process between the requester 140 and the offerer 130 may be done solely through the resource management computing system 110. Alternatively, the resource management computing system 110 may permit less than an entire agreement process between the offerer 130 and the requester 140 within the system 110. Even further, in one embodiment, the entire agreement process may be done outside the resource management computing system 110. In one example, the resource management computing system 110 may be passive with respect to how much of the negotiation process takes place within the system 110. Thus, the offerer 130 and requester 140 may exit the employee exchange process 200 to further negotiate and/or finalize an agreement to exchange an employee from the offerer 130 to the requester 140. In either case, the resource management system 110 may be configured to receive and store the final agreement between the offerer 130, and the requester 140.

During the exchange of the employee from the offerer 130 to the requester 140, the resource management computing system 110 may be configured to track and/or control certain aspects of the agreement (step 250). For example, the resource management computing system 110 may be configured to invoice, receive, and/or transfer fees paid for the exchanged employee to the offerer 130, and/or coordinate the replacement of an exchanged employee if the employee is no longer available or not suitable for the work desired by the requester 140. In addition, the resource management computing system 110 may be configured to charge at least one of the offerer 130 or the requester 140 a service fee associated with the term of the exchange of the employee.

The employee exchange process 200 may also include a concluding process (step 260). The concluding process may include verifying that the exchange of the employee has ended and the employee is back with the offerer 130. This event may be entered into the resource management computing system 110 by either the offerer 130 or the requester 140. The ending of the employee exchange may provide a trigger for additional steps. For example, a final invoice may be triggered within the resource management computing system 110 and provided to the requester. In addition or alternatively, the ending of the employee exchange may trigger a request for feedback from both the requester 140 and the offerer 130 regarding the exchanged employee and the transaction experience within the resource management computing system 110.

According to one embodiment, the employee exchange process 200 discussed above may provide a secure method to temporarily exchange idle human capital to those entities in need of such capital. Employees and entities can benefit from this process by maintaining a more stabilized workforce, and maintaining their intellectual capital, while offering employees the opportunity to remain part of an entity for the purpose of pay and benefits during times when internal demand for the employee's services is low. The employee exchange process 200 may also assist in reducing employee recruiting costs and workforce turbulence that negatively affect a entities' profitability. In addition, the employee exchange process 200 may assist entities in retaining their investment in human capital while increasing profitability. Finally, the employee exchange process 200 may drive innovation in participating entities by creating a more strategic, creative workforce, while enabling employees to gain new exposure to technology, process, and/or disciplines used by these other entities. In fact, the employee exchange process 200 may be initiated for the purpose of introducing an employee to a new technology, process, and/or discipline.

It will be apparent to those skilled in the art that various modifications and variations can be made to the above discloses systems and processes. It is intended that the specification and examples be considered as exemplary only, with a true scope of the disclosed embodiments being indicated by the following claims and their equivalents.

1. A method for temporarily exchanging one or more underutilized employees to increase utilization of the employees skills, comprising:
providing access to a resource system to at least one offerer and at least one requester, the access being provided over an electronic network, wherein each of the resource system, offerer, and requester are separate entities;
allowing the offerer to post within the resource system data associated with one or more underutilized employees currently under the employ of the offerer and performing one or more services for the offerer;
allowing the requester to view, in response to a search within the resource system, a data record associated with the posted one or more employees of the offerer;
facilitating, within the resource system, an agreement process between the offerer and the requester to exchange the employee from the offerer to the requester for a limited time, the resource system being owned by a resource service entity that is separate from the offerer and the requester;
verifying termination of the exchange and that the employee is back with the offerer to perform one or more services for the offerer.

2. The method of claim 1, wherein the providing access to the resource system includes authenticating an offerer or requester.

3. The method of claim 1, wherein the providing access to the resource system includes verifying that the at least one offerer has met one or more pre-determined conditions.

4. The method of claim 3, wherein providing access to the resource system includes requiring the entity to agree to terms of the resource system.

5. The method of claim 1, wherein the resource system is accessible over the Internet.

6. The method of claim 1, wherein the posting of the one or more employees includes identifying attributes of an employee.

7. The method of claim 6, wherein the posting of the one or more employees includes posting a trust indicator.

8. The method of claim 6, wherein the locating of the one or more posted employees includes matching desired attributes from the requester to the identified attributes of the one or more posted employees.

9. The method of claim 8, wherein the matching includes providing weighted matching results to the requester.

10. The method of claim 1, wherein the facilitating of an agreement process between the offerer and the requester includes the requester communicating with the offerer within the resource system.

11. The method of claim 10, wherein the identity of the offerer is hidden to the requester during at least a portion of the agreement process.

12. The method of claim 11, wherein the facilitating of an agreement process includes enabling access to at least one of a non-disclosure agreement or an employment agreement within the resource system.

13. The method of claim 1, wherein the resource system tracks an exchange of an employee from the offerer to the requester.

14. The method of claim 1, wherein the resource service entity charges a fee associated with an agreement for an exchange of the one or more employees.

15. A method for temporarily exchanging one or more underutilized employees to increase utilization of the employees skills, comprising:
providing membership-based access to a resource system to at least one offerer and at least one requester, the access being provided over an electronic network, wherein each of the resource system, offerer, and requester are separate entities;
allowing the offerer to post on the resource system data associated with one or more underutilized employees currently under the employ of the offerer and performing one or more services for the offerer, the posting including a plurality of attributes of the one or more employees;
allowing the requester to view, in response to a search within the resource system, a data record associated with the posted employees of the offerer based on requested attributes;
facilitating, over the resource system, an agreement process between the offerer and the requester to exchange the employee from the offerer to the requester for a limited time, the agreement process including enabling access to at least one of a non-disclosure agreement or an employment agreement within the resource system, the resource system being owned by a resource service entity that is separate from the offerer and the requester;
tracking an agreement reached between the requester and offerer within the resource system;
verifying, over the resource system, in response to an input by the offerer or the requester, that the exchange of the employee has concluded and the employee is back with the offerer to perform one or more services for the offerer; and
automatically generating and providing a final invoice to the requestor.

16. The method of claim 15, wherein the posting of the one or more employees includes posting a trust indicator.

17. The method of claim 15, wherein the identity of the offerer is hidden from the requester during at least a portion of the agreement process.

18. (canceled)

19. A method for temporarily exchanging one or more underutilized employees to increase utilization of the employees skills, comprising:
providing access to a resource system to at least one offerer, and at least one requester, the access being provided over a network, wherein each of the resource system, offerer, and requester are separate entities;
allowing the offerer to post on the resource system data associated with one or more underutilized employees currently under the employ of the offerer and performing one or more services for the offerer, the posting including a plurality of attributes and opportunities of training in one or more deficient technologies of the one or more employees, including a trust indicator,
allowing the requester to view, in response to a search within the resource system, a data record associated with the one or more posted employees of the offerer based on requested attributes;
facilitating, within the resource system, an agreement process between the offerer and the requester to exchange the employee from the offerer to the requester for a limited time, the resource system being owned by a resource service entity that is separate from the offerer and the requester, wherein the agreement includes training by the requestor of the employee in the one or more deficient technologies;
hiding the identity of the offerer from the requester during at least a portion of the agreement process; and
verifying termination of the exchange and that the employee is back with the offerer to perform one or more services for the offerer.

20. The method of claim 19, wherein a portion of the agreement process includes communication between the offerer and requester outside the resource system.

21. A system for exchanging one or more employees, the system comprising:
an electronic storage device storing instructions for administering a resource management system; and
a processor configured to execute instructions to perform a method of:
providing access to a resource system to at least one offerer and at least one requester, the access being provided over an electronic network;
allowing the offerer to post within the resource system data associated with one or more underutilized employees currently under the employ of the offerer and performing one or more services for the offerer to increase utilization of the employees skills;
allowing the requester to view, in response to a search within the resource system, a data record associated with the posted one or more employees of the offerer;
facilitating, within the resource system, an agreement process between the offerer and the requester to exchange the employee from the offerer to the requester for a limited time, the resource system being owned by a resource service entity that is separate from the offerer and the requester; and
verifying termination of the exchange and that the employee is back with the offerer to perform one or more services for the offerer.
